(19) United States
(12) Patent Application Publication
(10) Pub. No.: US 2006/0002637 A1
(43) Pub. Date: Jan. 5, 2006

(54) Profiled rail guide

(76) Inventors: Wolfgang Bauer, Riegelsberg (DE); Bettina Rudy, Kleinbundenbach (DE)

Correspondence Address: HEDMAN & COSTIGAN P.C., 1185 AVENUE OF THE AMERICAS, NEW YORK, NY, 10036, US

(21) Appl. No.: 11/170,179

(22) Filed: Jun. 29, 2005

(30) Foreign Application Priority Data
Jun. 30, 2004 (DE) 10 2004031 497.7

(51) Int. Cl. F16C 19/00

(52) U.S. Cl. 384/55

(57) ABSTRACT

In a profiled rail guide comprising a traveling carriage that is supported through a carrier body (3) on a guide rail (1) for sliding along the guide rail (1) on raceways (2) that are arranged on two long sides of the guide rail (1), the carrier body (3) comprises at least one of longitudinal holes (5, 6) extending parallel to the guide rail (1) and transverse holes (7) extending at right angles to the guide rail (1).

### FIELD OF THE INVENTION

The invention concerns a profiled rail guide comprising a traveling carriage that is supported through a carrier body on a guide rail for sliding along the guide rail on raceways that are arranged on two long sides of the guide rail.

### BACKGROUND OF THE INVENTION

Guides are used, for example, on machine tools. They serve the purpose of providing an exact linear traveling path for components that have to execute a feed or cutting motion. In many cases of use, there is a demand for high traveling speeds and appropriately high accelerations.

German patent DE 44 13 373 C2 discloses a profiled rail guide of the pre-cited type in the form of a linear rolling bearing with a traveling carriage whose carrier body and guide rail have a solid configuration. The components of such a standard system certainly have a high rigidity but they also have the drawback that during the reciprocating motion, a large mass has to be periodically accelerated and braked again depending on which of the two components is moved relative to the other, so that a high consumption of energy results.

From the published patent application DE 43 13 074 A1, it is also known to make a guide rail for rolling load carriers out of an extruded hollow-chamber profile so as to keep material consumption low. However, the hollow chambers of the guide rail are generally only accessible from the front ends of the guide rail.

### OBJECTS OF THE INVENTION

It is an object of the invention to provide the lightest possible profiled rail guide that is suitable for highly dynamic applications. Another object is to reduce the required driving power through a reduction of weight of the components used in such a guide.

These and other objects and advantages of the invention will become obvious from the following detailed description.

### SUMMARY OF THE INVENTION

According to a first proposition of the invention, the above objects are achieved by the fact that the carrier body comprises at least one of longitudinal holes extending parallel to the guide rail and transverse holes extending at right angles to the guide rail. At least one of said longitudinal holes and said transverse holes of the carrier body may be made as at least one of bores and slots. The traveling carriage can be supported on the guide rail through its carrier body via recirculating rolling elements.

According to a further proposition of the invention, the above objects are achieved by the fact that the guide rail comprises a lower longitudinal groove that starts from a bottom surface of the guide rail and an upper longitudinal groove that starts from a top surface of the guide rail. The longitudinal grooves of the guide rail can have a triangular or a trapezoidal cross-section. A trapezoidal longitudinal groove can have a width dimension that corresponds to the longer parallel side of the trapezoid and is equal to ¾ of the width of the guide rail. The height of the trapezoid can be chosen to be equal to ⅓ of the height of the guide rail.

A filling body of a light, stiff material can be inserted into at least one of the lower and the upper longitudinal grooves. The material can be a carbon fiber reinforced plastic.

One example of embodiment of the invention is illustrated in the drawing and will be described more closely below.

### BRIEF DESCRIPTION OF THE DRAWING

FIG. 1 is a perspective view of a guide rail and a carrier body that can travel along this guide rail,

FIG. 2 is a perspective view of the guide rail, and

FIG. 3 is an end view of the profiled rail guide of FIG. 1.

### DETAILED DESCRIPTION OF THE DRAWING

A profiled rail guide comprises a straight guide rail 1 that comprises raceways 2 on both its long sides. A U-shaped carrier body 3 is supported through its two U-legs via rolling elements 4 on these raceways 2. The carrier body 3 partially surrounds the guide rail 1. The rolling elements 4 may be configured, for example, as balls arranged in endless circuits in the carrier body 3. The balls enable the carrier body 3 to travel along the guide rail 1 in its longitudinal direction.

To keep the mass of the carrier body 3 as small as possible, three parallel longitudinal holes are arranged in its U-web region. A central longitudinal hole 5 in the form of a bore is flanked by two lateral longitudinal holes 6 in the form of slots Besides this, for reducing the mass of the carrier body 3, a transverse hole 7 extending at right angles to the longitudinal holes 5 and 6 is also arranged in the U-web region.

For reducing the mass of the guide rail 1, two grooves are arranged therein and extend in the length direction of the guide rail. The lower one of these longitudinal grooves 8 starts from the flat bottom surface 9 of the guide rail 1 and the upper one of these longitudinal grooves 10 starts from the flat top surface 11 of the guide rail 1, the bottom and top surfaces 9 and 11 being parallel to each other. Both the longitudinal grooves 8 and 10 have a trapezoidal cross-section, the longer parallel side of the trapezoid of the lower longitudinal groove 8 being situated in the plane of the bottom surface 9 and the longer parallel side of the trapezoid of the upper longitudinal groove 10 being situated in the plane of the top surface 11.

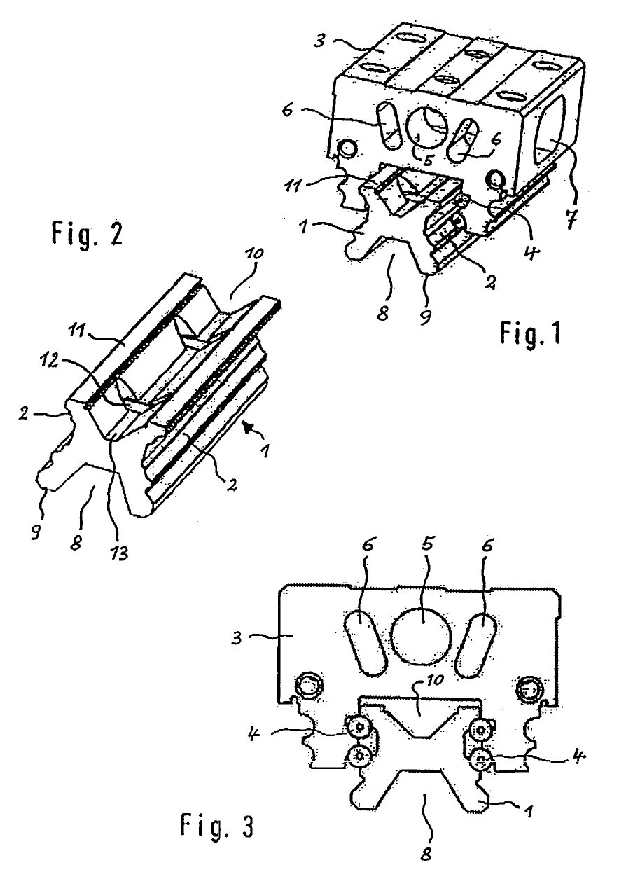

As can be seen from FIG. 1, the guide rail 1 together with the carrier body 3 forms a recirculating ball guide in which two circuits of rolling elements 4 are arranged on each long side of the guide rail 1 and the respective U-leg of the carrier body 3. The outer dimensions of the guide rail 1 and the carrier body 3 correspond to those of corresponding components of the standard system mentioned above. The system of the invention has the same basic load rating as the standard system. Due to the reduction of weight, the rigidity of the inventive system is lower than that of the standard system but is distinctly higher than 50% of the rigidity of the standard system.

The weight of the guide rail 1, also illustrated in FIG. 2, is reduced to a value of 70% of the weight of the standard guide rail. The weight reduction is achieved through the two trapezoidal longitudinal grooves 8 and 10 that start respectively from the bottom surface 9 and the top surface 11. In place of the longitudinal grooves 8 and 10 with trapezoidal cross-sections, grooves with a triangular cross-section may also be used. On the outer side, the size of the trapezoid can be about ⅔ of the width of the guide rail 1 and on the inner side, less than ⅓ of the width of the guide rail 1. The height of the trapezoid is, for example, about ⅓ of the height of the guide rail 1.

The use of screws inserted into screw holes 12 of the guide rail 1 for fixing the guide rail 1 on a connecting component results in an increase of rigidity of the guide rail 1. For further increasing the rigidity, the plane of the screw support surface 13 of the inventive guide rail 1 can be situated at a different level from the bottom surface 9 than in a standard rail. In this case, screws with a reduced head height must be used. Besides this, the rigidity of the guide rail 1 can be increased further by inserting filling bodies of suitable materials, e.g. glass fiber or carbon fiber reinforced plastic, into the lower longitudinal groove 8 and/or into the upper longitudinal groove 10. It is possible in this case, to attain almost the same rigidity as in a standard guide rail, while, at the same time, the weight of the thus filled guide rail does not exceed 70% of the weight of a corresponding standard rail.

In the profiled rail guide of the invention, only those regions of the guide rail 1 and the carrier body 3 have a solid configuration that are subjected to compressive, tensile and side forces. The carrier body 3 comprises the largest possible empty spaces both in the longitudinal direction and in the direction extending crosswise thereto. This is realized through the longitudinal holes 5 and 6 and the transverse hole 7, all of which also relieve the central region of the carrier body 3. In the guide rail 1, the non-loaded material extending parallel to the raceways 2 has been removed. This was achieved through the arrangement of the lower longitudinal groove 8 and the upper longitudinal groove 10.

If only the traveling carriage is moved and thus undergoes even strong accelerations, it is also possible in such an application to combine the carrier body 3 of the invention with a standard rail. If, on the other hand, only the guide rail 1 is moved and thus undergoes even strong accelerations, it is possible in this application to combine the guide rail 1 of the invention also with standard carrier bodies.

1. A profiled rail guide comprising a traveling carriage that is supported through a carrier body on a guide rail for sliding along the guide rail on raceways that are arranged on two long sides of the guide rail, wherein the carrier body comprises at least, one of longitudinal holes extending parallel to the guide rail and transverse holes extending at right angles to the guide rail.

2. A rail guide of claim 1, wherein at least one of said longitudinal holes and said transverse holes of the carrier body are made as at least one of bores and slots.

3. A rail guide of claim 1, wherein the traveling carriage is supported on the guide rail through the carrier body via recirculating rolling elements.

4. A profiled rail guide comprising a traveling carriage that is supported through a carrier body on a guide rail for sliding along the guide rail on raceways that are arranged on two long sides of the guide rail, wherein the guide rail comprises a lower longitudinal groove that starts from a bottom surface of the guide rail and an upper longitudinal groove that starts from a top surface of the guide rail.

5. A rail guide of claim 4, wherein the longitudinal grooves of the guide rail have one of a triangular cross-section and a trapezoidal cross-section.

6. A rail guide of claim 5, wherein a longitudinal groove having the trapezoidal cross-section has a width dimension that corresponds to the longer parallel side of a trapezoid and is equal to ¾ of a width of the guide rail.

7. A rail guide of claim 5, wherein a longitudinal groove having the trapezoidal cross-section has a trapezoid height that is equal to ⅓ of a height of the guide rail.

8. A rail guide of claim 4, wherein a filling body of a light, stiff material is inserted into at least one of the lower and the upper longitudinal grooves.

9. A rail guide of claim 8, wherein the material of the filling body is a carbon fiber reinforced plastic.
